(19) United States
(12) Patent Application Publication
(10) Pub. No.: US 2007/0276558 A1
(43) Pub. Date: Nov. 29, 2007

(54) Navigation system for position self control robot and floor materials for providing absolute coordinates used thereof

(76) Inventor: Kyeong-Keun Kim, Seoul (KR)

Correspondence Address: CANTOR COLBURN, LLP, 55 GRIFFIN ROAD SOUTH, BLOOMFIELD, CT, 06002, US

(21) Appl. No.: 10/594,183

(22) PCT Filed: Oct. 4, 2004
(86) PCT No.: PCT/KR04/02539

§ 371 Date: Sep. 25, 2006

(30) Foreign Application Priority Data
Mar. 27, 2004 (KR) 10-2004-0020981
Mar. 30, 2004 (KR) 20-2004-0008728
Jun. 25, 2004 (KR) 20-2004-0018102

(51) Int. Cl. G05D 1/02

(52) U.S. Cl. 701/23; 901/47

(57) ABSTRACT

A navigation system for a position self control robot including a main body having a locomotion unit is provided. The navigation system includes two-dimensional (2D) barcodes, a barcode reader, and a control unit. The 2D barcodes are formed at predetermined intervals on a floor having a predetermined size and respectively have different unique coordinate values. The barcode reader is installed at a predetermined position in a lower portion of the main body to read a 2D barcode on the floor. The control unit is installed at the main body to be electrically connected with the barcode reader, recognizes absolute coordinates within a predetermined area, which are stored in memory, based on a unique coordinate value of the 2D barcode read by the barcode reader, applies the absolute coordinates to a programmed locomotion algorithm, and controls the locomotion unit to move the main body.

### TECHNICAL FIELD

The present invention relates to a navigation system for a position self control robot having a main body with a locomotion unit, and more particularly, to a navigation system that acquires an exact current position of a position self control robot which is moving or operating and that quickly calculates a relative distance between the position self control robot and each of a predetermined obstacle and a predetermined move restriction line to enable the position self control robot to quickly and accurately move in accordance with a programmed locomotion algorithm or a stored traveling path. In addition, the present invention relates to a floor material for providing absolute coordinates, which includes two-dimensional (2D) barcodes having different unique coordinate values at predetermined intervals to enable the position self control robot to quickly acquire a current absolute position, where the 2D barcodes does not show color at visible rays but show color at 300-850 nm wavelength light radiated thereto when the position self control robot is moving so that the floor material have a beautiful appearance.

### BACKGROUND ART

Position self control robots generally have been developed from robots widely spread in industrial fields and are being widely used in government and public offices, companies, home, etc.

Such position self control robots are utilized for self control cleaners that autonomously move and clean a predetermined area without a user's manual control. To autonomously move, a position self control robot needs to accurately recognize its current position and accurately calculate a moving direction and a moving distance.

To meet these necessities, conventionally, an odometry has been developed. A position self control robot using the conventional odometry obtains speed information using an odometer or a wheel sensor and azimuth information using a magnetic sensor and calculates a moving distance from an initial position to a next position and a moving direction, thereby recognizing the position and direction thereof.

FIG. 1 illustrates the typical concept of recognizing a position and a direction in an odometry coordinate system. In the odometry coordinate system, the position of a position self control robot 1 is defined by coordinates xᵣ and yᵣ where a rotation center 2 of the position self control robot 1 is located and the direction of the position self control robot 1 is defined by an angle tᵣ between the front direction of the position self control robot 1 and an x-axis.

The conventional odometry depends on spontaneously occurring information without using externally input information and enables position information to be acquired at a very high sampling rate, thereby updating the position information very fast. In addition, the odometry provides high accuracy for a short distance and low cost.

However, since the odometry calculates a position and a direction using integration, as a traveling distance increases, a measurement error is accumulated. In particular, an error occurring due to slippage that may occur due to a floor material in a move area is accumulated without being compensated for, thereby decreasing accuracy.

An improved method of recognizing a position and a direction using odometry is a method using a radio frequency identification (RFID) card and an RFID reader.

A plurality of RFID cards having unique position information are laid in a floor in an area in which the position self control robot 1 moves. Then, the position self control robot 1 detects an RFID card using an RFID reader while moving on the floor and reads unique position information, thereby recognizing a current position thereof.

FIG. 2 illustrates the concept of recognizing a position and a direction in an RFID coordinate system. The current position of the position self control robot 1 is defined by coordinates x_{c} and y_{c} of an RFID card 3 detected by the position self control robot 1 among a plurality of RFID cards 3 laid in a matrix pattern in a floor 5 within a move area. Unique numbers are respectively stored in the RFID cards 3 and the position self control robot 1 has RFID coordinate values respectively corresponding to these unique numbers in a form of a reference table. The position self control robot 1 detects one RFID card 3 and acquires the unique number of the RFID card 3 using an RFID reader 4 and finds an RFID coordinate value corresponding to the acquired unique number in the reference table, thereby recognizing the current position thereof.

In the method using RFID, accuracy of the position self control robot recognizing a position and a direction is determined according to a distribution density of the RFID cards 3. When the distribution density of the RFID cards 3 is too low, the position self control robot 1 cannot be expected to accurately recognize the position and the direction. When the distribution density of the RFID cards 3 is too high, an error may occur in reading a unique number due to interference between RF signals output from RFID cards 3a, 3b, and 3c, as illustrated in FIG. 3.

Accordingly, to prevent the occurrence of an error, the distribution density of the RFID cards 3 must be restricted to an appropriate range. Such restriction causes the accuracy of the method using the RFID to decrease. In addition, an error may also occur when a substance absorbing a magnetic field is present in a place where the RFID cards 3 are laid.

Moreover, to recognize the direction in the method using the RFID, as shown in FIG. 3, two or more RFID cards 3a, 3b, and 3c need to be simultaneously recognized. When the distribution density of the RFID cards 3 is not high enough, recognition of the direction becomes difficult.

In particular, it is inconvenient to lay the RFID cards 3 in the floor 5. When an RFID card 3 is broken, the floor 5 needs to be entirely repaired or the broken RFID card 3 needs to be extracted and a new RFID card 3 need to be laid in the floor 5, which spoils the appearance of the floor 5.

Furthermore, since in a wide area, a lot of RFID cards 3 need to be used, high installation cost and high maintenance cost are incurred and careful treatment is needed during maintenance in operating the position self control robot 1.

### DISCLOSURE OF THE INVENTION

The present invention provides a navigation system by which a current position (i.e., an absolute coordinate value) of a position self control robot is prevented from being interfered with an identification unit corresponding to an adjacent absolute coordinate value to easily acquire the current position of the position self control robot, when an obstacle is recognized within a predetermined area, relative coordinate value of the obstacle and a distance between the exact current position of the position self control robot and the obstacle are quickly and accurately calculated or recognized to reliably control a moving direction and distance of the position self control robot, different unique position information is easily installed in any place, and maintenance is facilitated.

The present invention also provides a floor material having a two-dimensional (2D) barcode that is invisible to the naked eyes, thereby preventing the appearance of the floor material from being ruined and that shows color only when an absolute coordinate value is acquired, thereby allowing unique information (i.e., the absolute coordinate value) corresponding to the 2D barcode to be acquired.

According to an aspect of the present invention, there is provided a navigation system for a position self control robot 101 including a main body 102 having a locomotion unit. The navigation system includes 2D barcodes 104, a barcode reader 105, and a control unit. The 2D barcodes 104 are formed at predetermined intervals on a floor 103 having a predetermined size and respectively have different unique coordinate values. The barcode reader 105 is installed at a predetermined position in a lower portion of the main body 102 to read a 2D barcode 104 on the floor 103. The control unit is installed at the main body 102 to be electrically connected with the barcode reader 105, recognizes absolute coordinates within a predetermined area, which are stored in memory, based on a unique coordinate value of the 2D barcode 104 read by the barcode reader 105, applies the absolute coordinates to a programmed locomotion algorithm, and controls the locomotion unit to move the main body 102.

The navigation system may further include a light emitting device 106 installed near the barcode reader 105 to emit light having a predetermined wavelength range to the floor 103. The light emitting device 106 may emit light having a wavelength range between 300 nm and 850 nm.

According to another aspect of the present invention, there is provided a floor material 110 for providing absolute coordinate information to enable a position self control robot 101 to recognize absolute coordinates in a move space. The floor material 101 includes at least one first sheet 111 made by reversely printing a plurality of 2D barcodes 104 respectively having different unique coordinate values at predetermined intervals on a rear side of a transparent material having a predetermined area and by forming an adhesive layer 111a on the rear side of the transparent material so that the 2D barcodes 104 are normally seen from a surface of the floor material 110.

The 2D barcodes 104 in the first sheet 111 may be printed using one of visible color ink and invisible secret ink (for example, ink visible when light having a predetermined wavelength range is radiated thereto). In the first sheet 111, the 2D barcodes 104 may be arranged at equal intervals in a matrix pattern or along a plurality of concentric circles.

According to still another aspect of the present invention, there is provided a floor material 110 for providing absolute coordinate information to enable a position self control robot 101 to recognize absolute coordinates in a move space. The floor material 110 includes a plurality of second sheets 112 each made by reversely printing a single 2D barcode 104 having a unique coordinate value on a rear side of a transparent material having a predetermined area and by forming an adhesive layer 112a on the rear side of the transparent material so that the 2D barcode 104 is normally seen from a surface of the floor material 110.

The 2D barcode 104 in each second sheet 112 may be printed using one of visible color ink and invisible secret ink.

The second sheets 112 may be arranged at equal intervals in a matrix pattern or along a plurality of concentric circles.

According to yet another aspect of the present invention, there is provided a floor material 110 for providing absolute coordinate information to enable a position self control robot 101 to recognize absolute coordinates in a move space. The floor material 110 includes a plurality of 2D barcodes 104 printed on a surface thereof at predetermined intervals. The 2D barcodes 104 respectively have different unique coordinate values.

The 2D barcodes 104 may be printed using one of visible color ink and invisible secret ink. The 2D barcodes 104 may be arranged at equal intervals in a matrix pattern or along a plurality of concentric circles.

The floor material 110 may further include a coating sheet 113 that is made of a transparent material and is bonded to the surface on which the 2D barcodes 104 are printed.

### BRIEF DESCRIPTION OF THE DRAWINGS

FIG. 1 illustrates the concept of recognizing a position and a direction in a conventional odometry coordinate system.

FIG. 2 illustrates the concept of recognizing a position and a direction in a conventional radio frequency identification (RFID) coordinate system.

FIG. 3 illustrates the occurrence of an error due to interference between conventional RFID cards.

FIG. 4 shows a state in which a position self control robot reads an absolute coordinate value from a floor material using a barcode reader according to the present invention.

FIG. 5 illustrates a navigation system for a position self control robot according to the present invention.

FIG. 6 illustrates a two-dimensional (2D) barcode according to the present invention.

FIG. 7A illustrates a floor material according to a first embodiment of the present invention.

FIG. 7B illustrates a state in which a 2D barcode is printed with transparent ink onto the floor material according to the first embodiment of the present invention.

FIG. 7C illustrates a state in which the floor material according to the first embodiment of the present invention is used.

FIG. 8A illustrates a floor material according to a second embodiment of the present invention.

FIG. 8B illustrates a state in which a 2D barcode is printed with transparent ink onto the floor material according to the second embodiment of the present invention.

FIG. 8C illustrates a state in which the floor material according to the second embodiment of the present invention is used.

FIG. 9A illustrates 2D barcodes arranged in a matrix pattern on the floor material according to the present invention.

FIG. 9B illustrates 2D barcodes arranged in a radial pattern on the floor material according to the present invention.

FIG. 10 illustrates a floor material according to a third embodiment of the present invention.

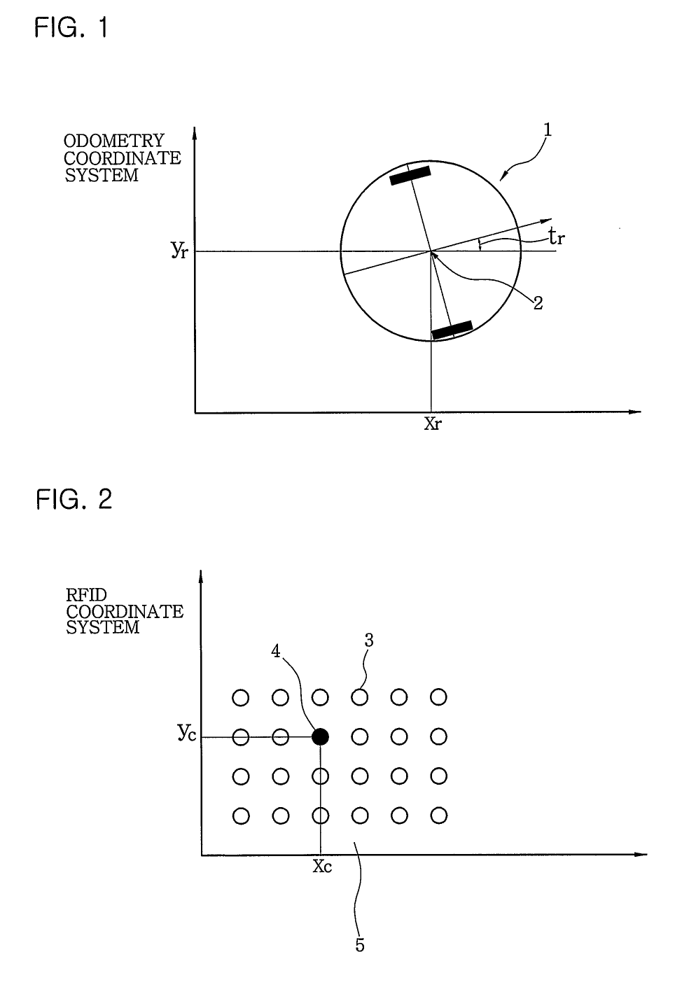

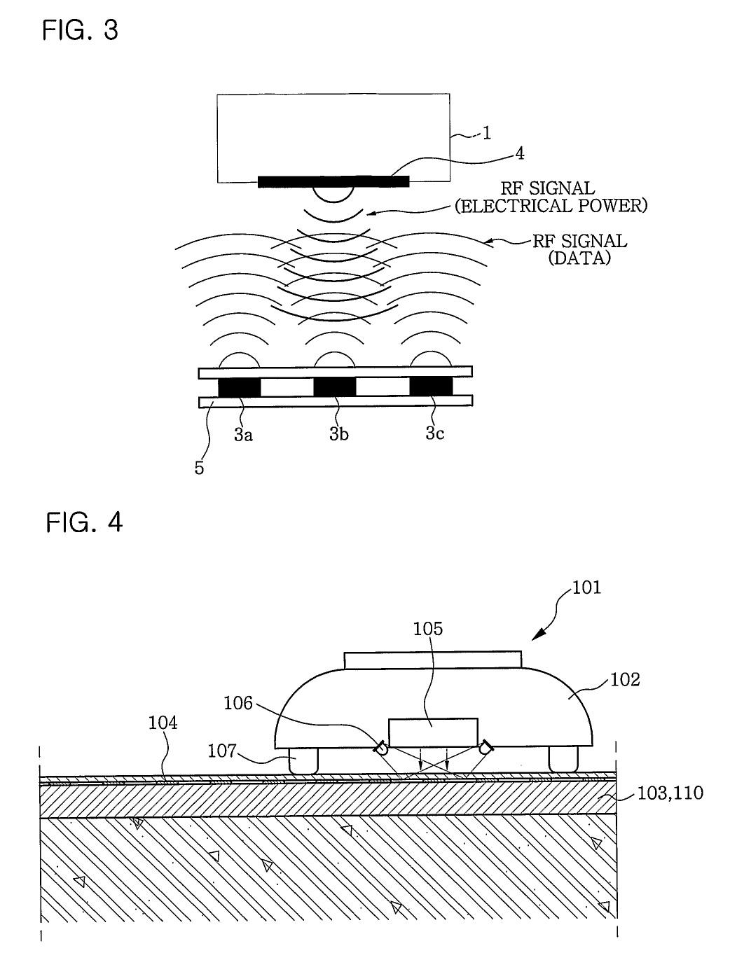

### BEST MODE FOR CARRYING OUT THE INVENTION

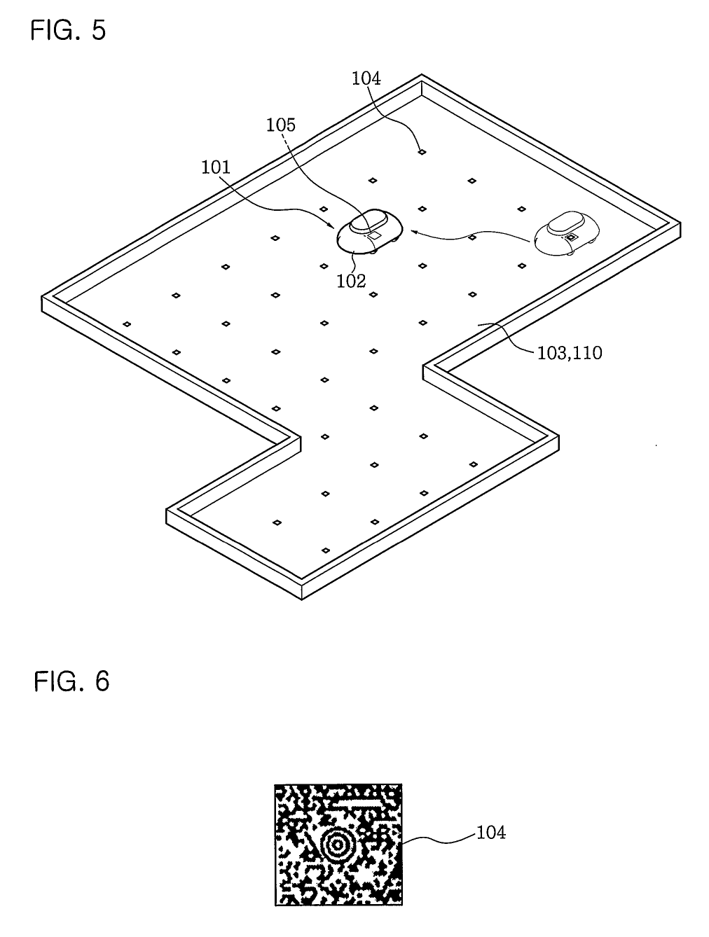

Hereinafter, the structure and operation of the present invention will be described in detail with reference to FIGS. 4 through 10.

A position self control robot 101 according to the present invention is not limited in a shape or form.

The present invention is provided to allow the position self control robot 101 to move effectively by enabling a control unit to accurately acquire absolute coordinates and control a locomotion unit. Accordingly, the locomotion unit may have a typical structure in which wheels 107 installed at a main body 102 are combined with driving motors that drive the wheels 107. A pair of sprockets and a driving motor may be installed at each of opposite sides of the main body 102 and a caterpillar may be installed at the pair of sprockets, but the present invention is not restricted thereto.

According to the present invention, an existing floor or specially manufactured floor paper or tile may be used for a floor 103.

In other words, two-dimensional (2D) barcodes 104 may be printed at predetermined intervals on the existing floor 103 or a sheet on which the 2D barcodes 104 have been printed may be attached to the existing floor 103. Alternatively, the 2D barcodes 104 may be printed on a specially manufacture floor paper or tile or the sheet on which the 2D barcodes 104 have been printed may be attached to the floor paper or tile.

The 2D barcodes 104 are symbols or symbol systems representing information in a pattern having various widths, as shown in FIG. 6. In the present invention, the 2D barcodes 104 may be implemented in various formats.

In other words, each 2D barcode 104 may be implemented as any single figure such as a sing, a number, or a special character that contain particular information. For example, in the 2D barcode 104 shown in FIG. 6, data is arranged in two axes (i.e., in an X-axis direction and a Y-axis direction) and is leveled. Such 2D barcode 104 is advantageous in that a large amount of data can be stored at high density in a narrow area, a space use rate is very high, performance of detecting an error and restoring data from contaminated or damaged symbols is excellent, symbol printing and reading is easy because black and white elements are not bound to a side, and symbol reading can be performed in every 360° direction.

Since the 2D barcode 104 can be read in any direction, it can be quickly read. Therefore, the 2D barcode 104 is suitable for the present invention.

A range of a move area is set in memory of the position self control robot 101 in advance. In addition, absolute coordinate values within the move area are stored in the memory.

Accordingly, when the position self control robot 101 operates, a barcode reader 105 scans the floor 103 at which the position self control robot 101 is located to read the 2D barcode 104 and acquires a coordinate value recorded in the 2D barcode 104. Then, the control unit recognizes the acquired coordinate value as an absolute coordinate value within the predetermined move area, which is stored in the memory.

Then, the control unit uses the absolute coordinate value in a programmed locomotion algorithm and controls the locomotion unit to direct the main body 102 to a moving direction.

In other words, after a unique coordinate value of the 2D barcode 104 is read by the barcode reader 105, the control unit recognizes the unique coordinate value as absolute coordinates within the move area set in the memory and recognizes a current position (a current absolute position) of the position self control robot 101 within the move area.

When the current position (i.e., absolute coordinates) of the position self control robot 101 is known, a relative distance between the position self control robot and an obstacle can be calculated using a simple operation and the position self control robot 101 can move avoiding the obstacle due to the programmed locomotion algorithm.

Meanwhile, as in conventional technology, the present invention can also use an odometry coordinate system to recognize an obstacle and reset a traveling path and can use vision. In the present invention, a navigation system can be compensated using the odometry coordinate system, but the present invention is not restricted thereto.

The present invention is provided mainly to calculate relative coordinates of an obstacle and a relative distance to the obstacle and control the position self control robot 101 to move along a traveling path by easily acquiring absolute coordinates.

Meanwhile, referring to FIG. 4, a light emitting device 106 is installed near the barcode reader 105 installed at a lower portion of the main body 102 of the position self control robot 101 to emit light having a predetermined wavelength range to the floor 103. The light emitting device 106 may emit light having a wavelength range between 300 nm and 850 nm.

The light emitting device 106 is provided to develop color of transparent ink (i.e. secret ink) printed on the floor 110. The 2D barcode 104 printed using transparent ink, which will be described in detail later, is invisible to the naked eyes and shows color only at light having a predetermined wavelength range. Accordingly, it is preferable to read the 2D barcode 104 using the barcode reader 105 after the 2D barcode 104 is made visible by radiating light to the 2D barcode 104 using the light emitting device 106.

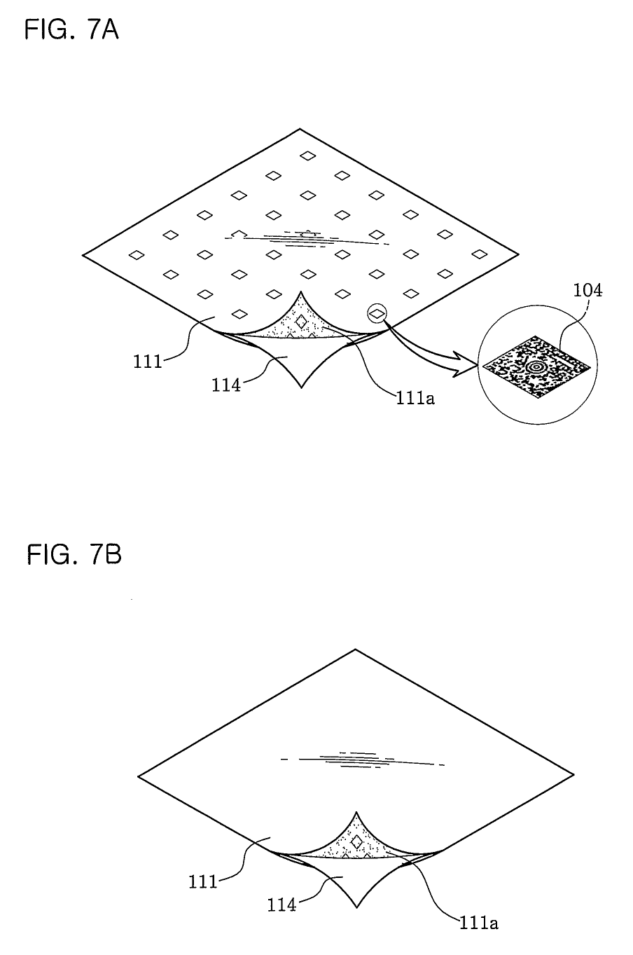

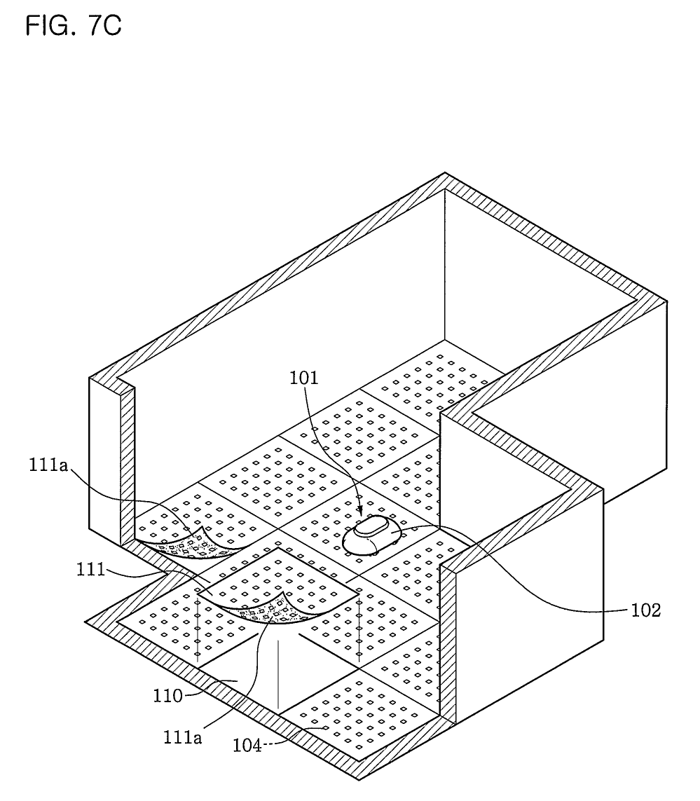

Meanwhile, a floor material 110 includes the 2D barcode 104. In the floor material 110 shown in FIG. 7A according to a first embodiment of the present invention, a plurality of 2D barcodes 104 respectively having different unique coordinate values are reversely printed at predetermined intervals on a rear side of a first sheet 111 made of a transparent material having a predetermined area.

Additionally, when a protective layer 114 is provisionally attached to an adhesive layer 111a, the first sheet 111 can be immediately and conveniently used by simply removing the protective layer 114.

For example, when the 2D barcodes 104 are printed in all directions at an interval of 30 cm on the first sheet 111 having a size of 180×180 cm in length and width, six 2D barcodes 104 are printed in each of lengthwise and widthwise directions. The 2D barcodes 104 may have position information like (0,0), (0,1), (0,2), (0,3), (0,4), (0,5), (1,0), (1,1), . . . , (5,4), (5,5). Such arrangement and design is also applied in the same manner when a second sheet 112 is attached to the floor material 110 according to a second embodiment and when the 2D barcodes 104 are directly printed on a surface of the floor material 110 according to a third embodiment.

Each of the 2D barcode 104 has unique position information. The plurality of the 2D barcodes 104 have different position information. When moving over a 2D barcode 104, the position self control robot 101 scans the 2D barcode 104, acquires the unique position information, and maintains or changes a current position, a traveling path, a moving direction, a moving speed, etc. in the move area based on the acquired position information.

The adhesive layer 111a is formed on a surface on which the 2D barcodes 104 are printed so that the first sheet 111 can be bonded to the floor material 110, as shown in FIG. 7C.

Here, since the first sheet 111 is transparent, the 2D barcodes 104 reversely printed on the rear side of the first sheet 111 can be seen through the surface in a normal position. It is preferable that the 2D barcodes 104 are printed on the first sheet 111 using either color ink visible to the naked eyes or invisible secret or transparent ink.

When the 2D barcodes 104 are printed using visible color ink, the beautiful appearance of the floor material 110 having inherent pattern and texture may be ruined. Accordingly, it is preferable that the 2D barcodes 104 are printed using invisible secret or transparent ink. Ink may be optionally selected by a manufacturer and a user.

Invisible transparent or secret ink used in the first through third embodiment of the present invention is typically used at present. When the invisible transparent or secret ink is used, a sign (including a number), a character, or a figure printed on security paper and securities such as paper money, bills, and gift certificates is not visible and cannot be copied or scanned.

The secret ink may be an organic fluorescent material, a quencher, or a cured resin composite, which emits 651-900 nm wavelength light in response to 300-850 nm wavelength light. Alternatively, the secret ink may be manufactured by making 1-litter A solution by mixing EC (i.e., 2-ethoxyethanol expressed by a molecular formula C4H1002) with methyl alcohol (MT) in proportion of 40-20% and by mixing the A solution with a 130-170 g CKR (i.e., a MgO reactive alkyl phenolic resin), 15-25 cc OX (C17H23CO2H), and 0.01-0.001 g Si. The present invention is not restricted thereto. However, the transparent or secret ink must be visible in response to the 300-850 nm wavelength light emitted by the light emitting device 106.

Since the secret or transparent ink is usually invisible but becomes visible when the position self control robot 101 radiates light having a predetermined wavelength range to acquire absolute coordinates, the appearance of the floor material 110 can be kept as it is.

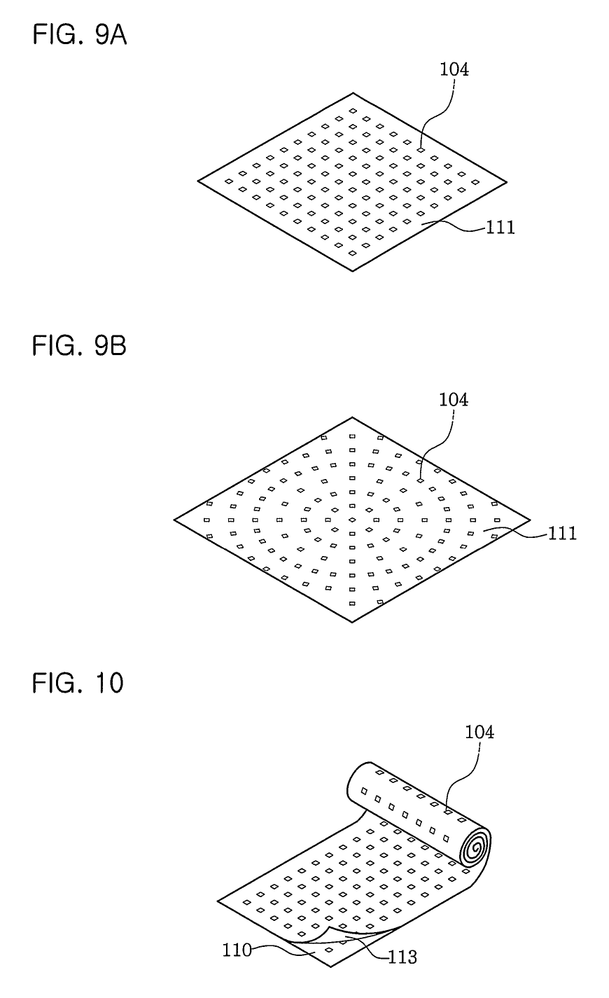

The 2D barcodes 104 may be arranged at equal intervals in a matrix pattern as shown in FIG. 9A or may be arranged at equal intervals along concentric circles virtually formed around a predetermined central point as shown in FIG. 9B. Such arrangement pattern may be selected according to the locomotion algorithm of the position self control robot acquiring absolute coordinates or may be selected to make the appearance of the floor material 110 beautiful.

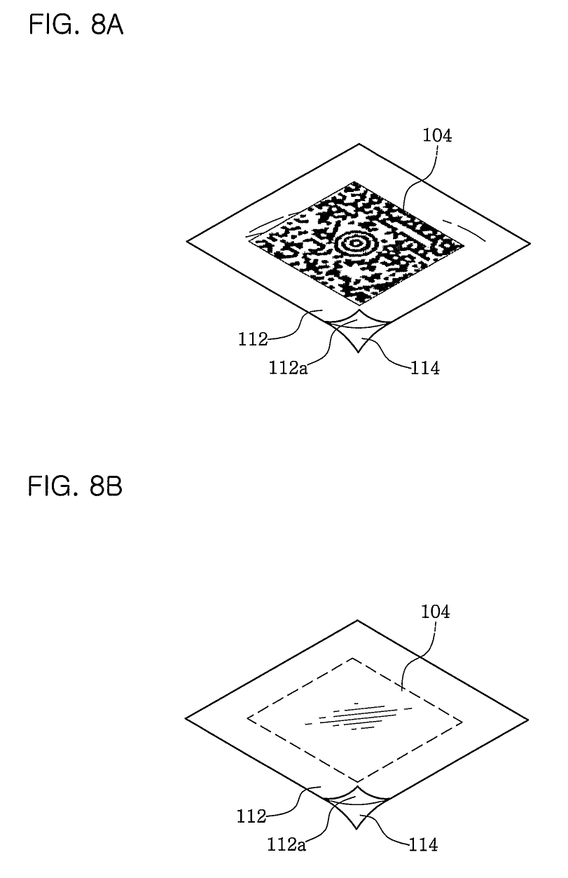

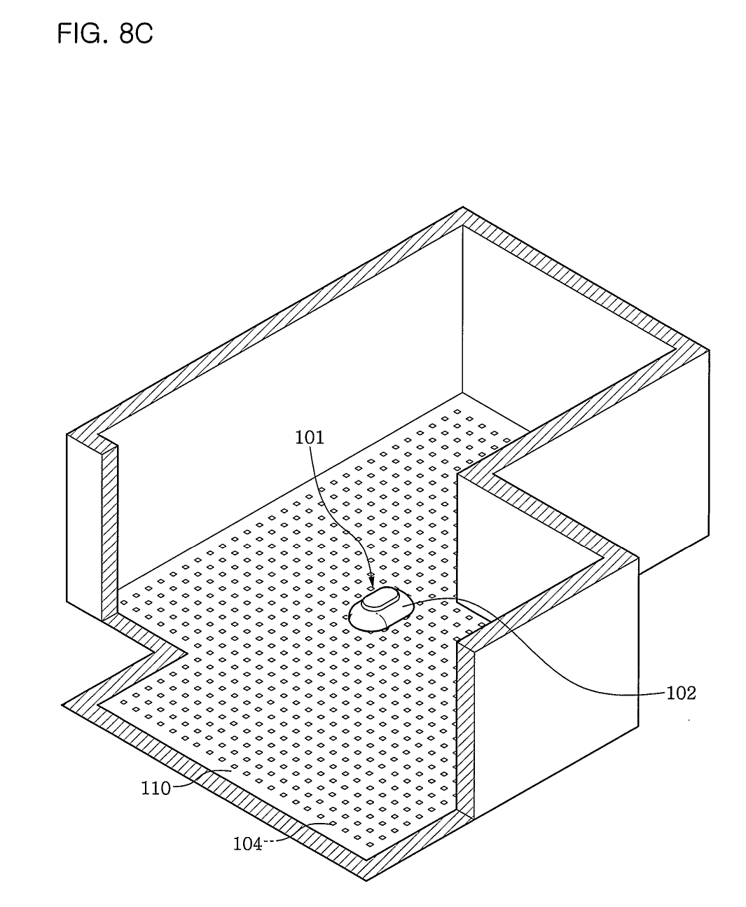

Referring to FIGS. 8A through 8C, which illustrates the second embodiment of the floor material 110, a single 2D barcode 104 having a unique coordinate value is printed on a rear side of the second sheet 112 made of a transparent material and an adhesive layer 112a is formed on the rear side on which the 2D barcode 104 is printed. A plurality of the second sheets 112 are directly bonded to the floor material 110.

Additionally, a protective layer 114 may be provisionally attached to the adhesive layer 112a so that the second sheet 112 can be immediately bonded to the floor material 110 after the protective layer 114 is removed.

In the second embodiment of the present invention, when the barcode reader 105 of the position self control robot 101 cannot recognize a unique coordinate value of the 2D barcode 104 damaged due to damage to the surface of the floor material 110, the damaged second sheet 112 can be easily replaced with a new one. Since only a small damaged portion can be easily replaced, maintenance is easy and maintenance cost is minimized.

Alternatively, a damaged 2D barcode 104 may be erased or removed, and then the 2D barcode 104 may be newly printed on a corresponding portion of the floor material 110 using a portable printer. Accordingly, a user can easily do repair by himself/herself and the floor material 110 can be kept from damage, and therefore, cost for maintenance and management can be reduced.

In the second embodiment of the present invention, the 2D barcode 104 may be printed using visible color ink as shown in FIG. 8A or may be printed using invisible secret or transparent ink as shown in FIG. 8B. As in the first embodiment, ink may be optionally selected by a manufacturer and a user.

In the second embodiment, a plurality of 2D barcodes 104 may also arranged on the floor material 110 at equal intervals in either the matrix pattern shown in FIG. 9A or the concentric circle pattern shown in FIG. 9B.

The first sheet 111 and the second sheet 112 may be bonded to the floor material 110 such as paper, boards, or tiles laid on the floor 103. Alternatively, as described above, the protective layer 114 may be attached to each of the adhesive layers 111a and 112a of the respectively first and second sheets 111 and 112 so that the first and second sheets 111 and 112 are bonded to the floor material 110 after the protective layer 114 is removed.

According to the third embodiment of the present invention, a plurality of 2D barcodes 104 respectively having different unique coordinate values are printed at predetermined intervals on the floor material 110, as shown in FIG. 10. As in the first and second embodiments, the 2D barcodes 104 may be printed selectively using either visible color ink or invisible secret or transparent ink. In addition, the plurality of 2D barcodes 104 may also arranged at equal intervals either in a matrix pattern or along a plurality of virtual concentric circles.

It is preferable that a coating sheet 113 made of transparent material is bonded to a surface of the floor material 110 after the 2D barcodes 104 are printed thereon so as to prevent the 2D barcodes 104 from being damaged. In the above-described embodiments of the present invention, the 2D barcodes 104 having absolute coordinate information have been explained. However, identifiers having the absolute coordinate information are not restricted to the 2D barcodes 104.

In other words, a directional sign or symbol that allows an angle and a direction to be calculated based on an angle and a centroid may serve as an identifier like a 2D barcode 104. Since such sign or symbol may include particular data, any one of the sign, the symbol, and the 2D barcode 104 that includes absolute coordinate information can be selectively used.

Since the 2D barcodes 104 are directly printed on the surface of the floor material 110 according to the third embodiment of the present invention, the printing can also be performed when the floor material 110 is molded. As a result, manufacturing time is reduced and productivity is increased.

It is preferable that the third embodiment is used for the floor material 110 like a floor paper that is cut in a predetermined length and rolled. When the 2D barcodes 104 are formed on the floor paper (i.e., the floor material 110) according to the third embodiment of the present invention, absolute coordinates that the position self control robot 101 refers to can be set in a predetermined area simply by installing the floor paper. As a result, working time taken to attach the first or second sheet 111 or 112 to the floor material 110 such as a floor paper can be reduced.

Meanwhile, since the 2D barcode 104 has been printed on the rear side of each of the first and second sheets 111 and 112 that are bonded to the floor material 110 in the first and second embodiments, the 2D barcode 104 is not damaged or broken by friction occurring on the surface of the floor material 110. In addition, since the coating sheet 113 made of a transparent material is bonded to the surface of the floor material 110 on which the 2D barcodes 104 have been printed in the third embodiment, the 2D barcodes 104 can be protected from external force such as surface friction.

### INDUSTRIAL APPLICABILITY

As described above, the present invention eliminates inconvenience of laying expensive RFID cards in a floor or changing the structure of a floor material to lay the RFID cards. In addition, the present invention allows a position self control robot to easily acquire absolute coordinates by simply attaching a sheet on which a 2D barcode is printed to a floor material such as a floor paper, a floor board, or a tile without using the expensive RFID cards, thereby maximizing the application of the position self control robot. Furthermore, the present invention allows the position self control robot to be used at low cost and can thus contribute to the wide spread of the position self control robot. In addition, according to the present invention, 2D barcodes can be easily installed on an existing floor material or on a new floor material during manufacturing. Since the 2D barcodes may be installed invisible, they do not ruin the beautiful appearance of a floor material.

What is claimed is:

1. A navigation system for a position self control robot including a main body having a locomotion unit, the navigation system comprising:
two-dimensional (2D) barcodes formed at predetermined intervals on a floor having a predetermined size, the 2D barcodes respectively having different unique coordinate values;
a barcode reader installed at a predetermined position in a lower portion of the main body to read a 2D barcode on the floor; and
a control unit installed at the main body to be electrically connected with the barcode reader, the control unit recognizing absolute coordinates within a predetermined area, which are stored in memory, based on a unique coordinate value of the 2D barcode read by the barcode reader, applying the absolute coordinates to a programmed locomotion algorithm, and controlling the locomotion unit to move the main body.

2. The navigation system of claim 1, further comprising a light emitting device installed near the barcode reader to emit light having a predetermined wavelength range to the floor.

3. The navigation system of claim 2, wherein the light emitting device emits light having a wavelength range between 300 nm and 850 nm.

4. A floor material for providing absolute coordinate information to enable a position self control robot to recognize absolute coordinates in a move space, the floor material comprising at least one first sheet made by reversely printing a plurality of two-dimensional (2D) barcodes respectively having different unique coordinate values at predetermined intervals on a rear side of a transparent material having a predetermined area and by forming an adhesive layer on the rear side of the transparent material so that the 2D barcodes are normally seen from a surface of the floor material.

5. The floor material of claim 4, wherein the 2D barcodes are printed using one of visible color ink and invisible secret ink.

6. The floor material of claim 4, wherein the 2D barcodes are arranged at equal intervals in a matrix pattern.

7. The floor material of claim 4, wherein the 2D barcodes are arranged at equal intervals along a plurality of concentric circles.

8. A floor material for providing absolute coordinate information to enable a position self control robot to recognize absolute coordinates in a move space, the floor material comprising a plurality of second sheets each made by reversely printing a single two-dimensional (2D) barcode having a unique coordinate value on a rear side of a transparent material having a predetermined area and by forming an adhesive layer on the rear side of the transparent material so that the 2D barcode is normally seen from a surface of the floor material.

9. The floor material of claim 8, wherein the 2D barcode is printed using one of visible color ink and invisible secret ink.

10. The floor material of claim 9, wherein the second sheets are arranged at equal intervals in a matrix pattern.

11. The floor material of claim 9, wherein the second sheets are arranged at equal intervals along a plurality of concentric circles.

12. A floor material for providing absolute coordinate information to enable a position self control robot to recognize absolute coordinates in a move space, the floor material comprising a plurality of two-dimensional (2D) barcodes printed on a surface thereof at predetermined intervals, the 2D barcodes respectively having different unique coordinate values.

13. The floor material of claim 12, wherein the 2D barcodes are printed using one of visible color ink and invisible secret ink.

14. The floor material of claim 12, wherein the 2D barcodes are arranged at equal intervals in a matrix pattern.

15. The floor material of claim 12, wherein the 2D barcodes are arranged at equal intervals along a plurality of concentric circles.

16. The floor material of claim 12, further comprising a coating sheet that is made of a transparent material and is bonded to the surface on which the 2D barcodes are printed.
